(19) United States
(12) Patent Application Publication
(10) Pub. No.: US 2012/0110221 A1
(43) Pub. Date: May 3, 2012

(54) APPARATUS FOR PROCESSING KEY INPUT USING INTERRUPT

(76) Inventors: Jae Kwon Jeong, Suwon-si (KR); Heung Soo Park, Namyangju-si (KR)

(21) Appl. No.: 12/944,857

(22) Filed: Nov. 12, 2010

(30) Foreign Application Priority Data
Oct. 29, 2010 (KR) 10-2010-0107273

(51) Int. Cl. G06F 13/24

(52) U.S. Cl. 710/48

(57) ABSTRACT

Provided is an apparatus for processing a key input using an interrupt. When a key is pressed, a key input signal and a key interrupt signal may be generated and transmitted to a control unit which may process the pressed input key. When the control unit receives the key interrupt signal, the control unit may identify an input key corresponding to the key input signal and process the identified input key.

### CROSS-REFERENCE TO RELATED APPLICATION

This application claims the benefit of Korean Patent Application No. 10-2010-0107273, filed on Oct. 29, 2010, in the Korean Intellectual Property Office, the disclosure of which is incorporated herein by reference.

### BACKGROUND

1. Field of the Invention

The present invention relates to an apparatus for processing a key input using an interrupt.

2. Description of the Related Art

A general key input circuit may check whether a signal was inputted to a key input port by periodically detecting (or, polling) the key input port. Also, the key input circuit ay process a value of the inputted signal.

A control unit of the key input circuit should poll the key input port even when a key is not frequently inputted. Accordingly, a waste of resources may occur.

When a key is inputted, and at the same time, an interrupt signal is generated and transmitted, the control unit of the key input circuit may detect and process a value of the inputted key only when the interrupt signal is generated.

Accordingly, the interrupt signal may contribute to the elimination of an unnecessary process and prevention of a waste of resources.

As the control unit does not perform an unnecessary process, a simple design of the entire system may be possible. As a result, the possibility of a malfunction or an error may be reduced.

### SUMMARY

According to an aspect of the present invention, there is provided an apparatus for processing a key input including: at least one input key; a key input signal generating unit electrically connected to each of the at least one input key; a key interrupt signal generating unit electrically connected to each of the at least one input key; and a control unit electrically connected to the key input signal generating unit and to the key interrupt signal generating unit. The key input signal generating unit may receive an electrical signal from a pressed input key among the at least one input key, and output a key input signal corresponding to the pressed key to the control unit. The key interrupt signal generating unit may receive the electrical signal from the pressed input key among the at least one input key, and output a key interrupt signal to the control unit. The control unit may process the pressed input key based on the key input signal outputted from the key input signal generating unit, when the control unit receives the key interrupt signal from the key interrupt signal generating unit.

The electrical signal generated by pressing the input key may be simultaneously is transmitted to the key input signal generating unit and to the key interrupt signal generating unit, and the key interrupt signal and the key input signal may be simultaneously inputted to the control unit.

Each of the at least one input key may have a switch, of which one end may be electrically connected to the key input signal generating unit and to the key interrupt signal generating unit, and when the input key is pressed, both ends of the switch may be electrically connected to each other.

The key input signal generating unit may include a first resistance and at least one second resistance. One end of the first resistance may be connected to a source voltage and the other end of the first resistance may be connected to one end of the at least one second resistance. The other end of the at least one second resistance may be electrically connected to one end of each of the at least one input key. The at least one second resistance may have different resistance values. The key input signal may be outputted via an electrical connection between the end of the first resistance and the end of the at least one second resistance, and the key input signal may have different voltages for each pressed input key. The control unit may identify the pressed input key based on the voltage of the key input signal.

The key interrupt signal generating unit may include a logic circuit having an output terminal and at least one input terminal. The logic circuit may perform a logic operation on the electrical signal inputted from the at least one input terminal and output a result of the logic operation to the output terminal. The output terminal may be electrically connected to the control unit, and each of the at least one input terminal may be electrically connected to one end of each of the at least one input key.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for processing a key input according to an embodiment of the present invention; and

FIG. 2 is a detailed block diagram illustrating the apparatus for processing a key input of FIG. 1.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

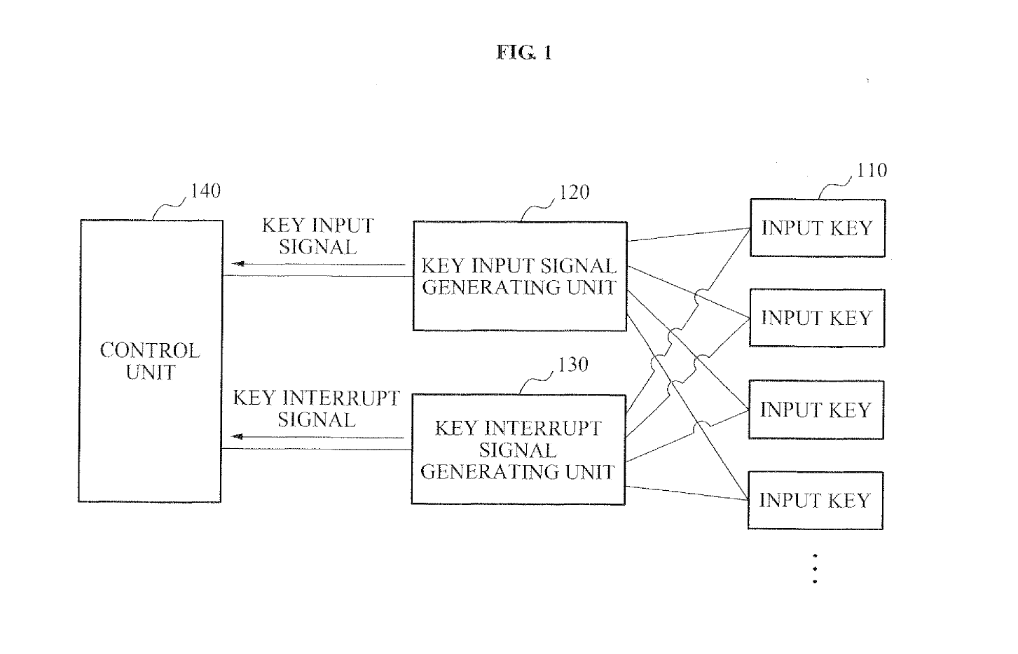

FIG. 1 is a block diagram illustrating an apparatus 100 for processing a key input according to an embodiment of the present invention.

The apparatus 100 for processing a key input may be a component of an electronic appliance, an image providing device, a display, and the like.

The apparatus 100 for processing a key input may include at least one input key 110, a key input signal generating unit 120, a key interrupt signal generating unit 130, and a control unit 140.

Each of the at least one input key 110 may be electrically connected to the key input signal generating unit 120. A signal transmitted from each of the at least one input key 110 to the key input signal generating unit 120 via the electrical connection may be an analog signal or a digital signal.

Each of the at least one input key 110 may be also electrically connected to the key interrupt signal generating unit 130. A signal transmitted from each of the at least one input key 110 to the key interrupt signal generating unit 130 via the electrical connection may be an analog signal or a digital signal.

When an input key is pressed, an electrical signal generated from the input key may be simultaneously transmitted to the key input signal generating unit 120 and to the key interrupt signal generating unit 130.

The control unit 140 may be electrically connected to the key input signal generating unit 120. A key input signal may be transmitted from the key input signal generating unit 120 to the control unit 140 via the electrical connection. The key input signal may be an analog signal or a digital signal.

The control unit 140 may be also electrically connected to the key interrupt signal generating unit 130. A key interrupt signal may be transmitted from the key interrupt signal generating unit 130 to the control unit 140 via the electrical connection. The key interrupt signal may be an analog signal or a digital signal.

The key input signal generating unit 120 may receive an electrical signal from a pressed input key among the at least one input key 110. The key input signal generating unit 120 may generate a key input signal corresponding to the pressed input key and output the generated key input signal to the control unit 140. The key input signal may include identity information for identifying the pressed input key. The identity information may be a voltage of the key input signal.

The key interrupt signal generating unit 130 may receive an electrical signal from a pressed input key among the at least one input key 110. The key interrupt signal generating unit 130 may generate a key interrupt signal and output the generated key interrupt signal to the control unit 140.

The key input signal and the key interrupt signal may be transmitted to the control unit 140 at the same time or within a predetermined time interval.

The control unit 140 may sense transmission of a key interrupt signal. For example, when a key interrupt signal is inputted to the control unit 140, an interrupt may occur in the control unit 140, and the control unit 140 may recognize that a key interrupt signal was transmitted, using the interrupt.

When the control unit 140 receives an input of the key interrupt signal, the control unit 140 may process a pressed input key based on the key input signal. A key input signal may include identity information for identifying the pressed input key, and the control unit 140 may identify the pressed input key using the identity information.

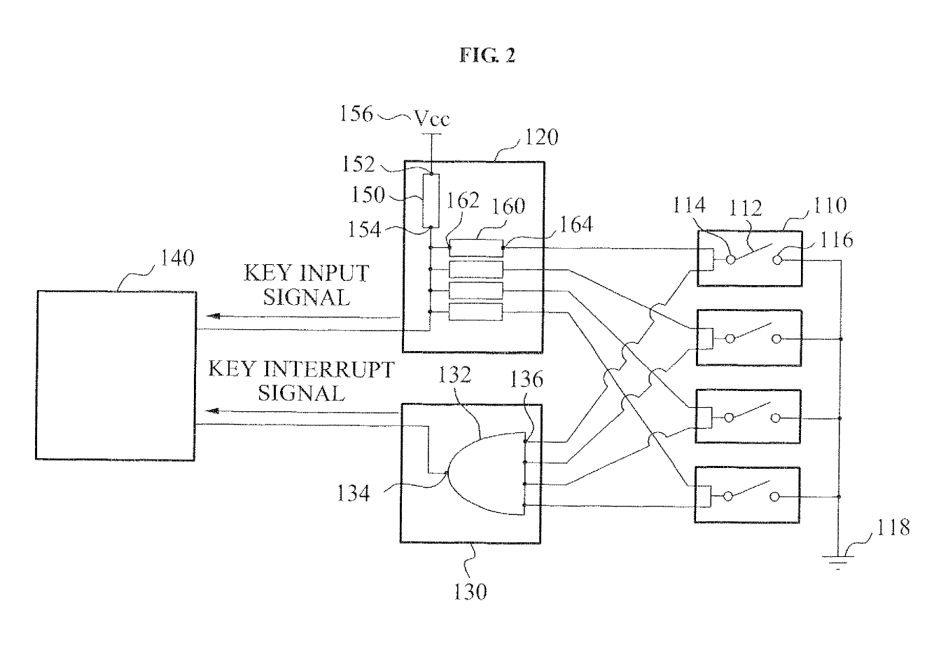

FIG. 2 is a detailed block diagram illustrating the apparatus 100 for processing a key input of FIG. 1.

Each of the at least one Input key 110 may have a switch 112.

One end 114 of the switch 112 may be electrically connected to the key input signal generating unit 120 and to the key interrupt signal generating unit 130. Accordingly, the key input signal generating unit 120 may be electrically connected to the key interrupt signal generating unit 130.

The other end 116 of the switch 112 may be electrically connected to a ground 118.

When the input key 110 is pressed, both ends 114 and 116 of the switch 112 may be electrically connected to each other.

The key input signal generating unit 120 may have a first resistance 150 and at least one second resistance 160.

One end 152 of the first resistance 150 may be connected to a source voltage (Vcc) 156. The other end 154 of the first resistance 150 may be connected to one end 162 of a second resistance, in particular, to one end 162 of each of the at least one second resistance 160 when the second resistance is plural.

The other end 164 of the at least one second resistance 160 may be electrically connected to the end 114 of each switch 112.

The at least one second resistance 160 may have different resistance values from each other.

A key input signal may be outputted via the electrical connection between the end 154 of the first resistance 150 and the end 162 of the second resistance 160.

In other words, a voltage of a key input signal may be a voltage at the end 154 of the first resistance 150 or the end 162 of the second resistance 160. Information for identifying a pressed key included in the key input signal may be a voltage of the key input signal or a voltage of an electrical connection between the key input signal generating unit 120 and the control unit 140.

When the switch 112 is pressed, an electrical connection may be established between the source voltage 156 and the ground 118 via the first resistance 150 and the second resistance 160 connected to the switch 112.

Accordingly, a voltage at the end 154 of the first resistance 150 may be determined based on a resistance value of the first resistance 150 and a resistance value of the second resistance 160.

As described above, the at least one second resistance 160 may have different resistance values from each other. Accordingly, a key input signal may have a variable voltage depending on the pressed input key 110.

The control unit 140 may identify the pressed input key 110 based on a voltage of the key input signal. Also, the control unit 140 may process the identified pressed input key 110.

The key interrupt signal generating unit 130 may include a logic circuit 132.

The logic circuit 132 may have an output terminal 134 and at least one input terminal 136. The logic circuit 132 may be a logic OR gate. The logic circuit 132 may perform a logic operation on an electrical signal inputted from the at least one input terminal 136. Also, the logic circuit 132 may output a result of the logic operation through the output terminal 134. The output terminal 134 may be electrically connected to the control unit 140.

When the logic operation result is a logic a key interrupt signal may be transmitted to the control unit 140, or the control unit 140 may recognize the logic ‘1’ as a key interrupt signal.

When the logic operation result is a logic ‘0’, a key interrupt signal may not be transmitted to the control unit 140, or the control unit 140 may recognize that a key interrupt signal was not transmitted.

Each of the at least one input terminal 136 may be electrically connected to the end 114 of each of the at least one input key 110.

When the switch 112 is pressed, an electrical connection may be established between the source voltage 156 and the ground 118 via the first resistance 150 and the second resistance 160 connected to the switch 112. Accordingly, an electric current may flow to the input terminal 136 connected to the switch 112, and in this instance, an input value of the input terminal 136 may represent a logic ‘1’.

When the switch 112 is not pressed, an electric current may not flow to the input terminal 136 connected to the switch 112, and in this instance, an input value of the input terminal 136 may represent a logic ‘0’.

The control unit 140 may sense a key interrupt signal outputted from the logic circuit 132 and process the sensed key interrupt signal.

As described above, the output terminal 134 of the logic circuit 132 may be one. Accordingly, a key interrupt signal generated by pressing the at least one input key 110 may be constructed as a single key interrupt signal.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. An apparatus for processing a key input, the apparatus comprising:
at least one input key;
a key input signal generating unit including a first resistor and at least one second resistor and electrically connected to each of the at least one input key;
a key interrupt signal generating unit including a logic circuit and electrically connected to each of the at least one input key; and
a control unit electrically connected to the key input signal generating unit and to the key interrupt signal generating unit,
wherein the logic circuit includes an output terminal and at least one input terminal
wherein the key input signal generating unit receives an electrical signal from a pressed input key among the at least one input key, and outputs a key input signal corresponding to the pressed key to the control unit, one end of the first resistor is connected to a source voltage and the other end of the first resistor is connected to one end of the at least one second resistor, of which the other end is electrically connected to one end of each of the at least one input key, the at least one second resistor having different resistances, and the key input signal is out putted via an electrical connection between the end of the first resistor and the end of the at least one second resistor, the key input signal having different voltages for each pressed input key,
wherein the key interrupt signal generating unit receives the electrical signal from the pressed input key among the at least one input key, and outputs a key interrupt signal to the control unit, the logic circuit performs a logic operation on the electrical signal inputted from the at least one input terminal and outputs, as the key interrupt signal, a logic value ‘0’ or a logic value ‘1’ corresponding to a result of the logic operation to the output terminal, the output terminal is electrically connected to the control unit, and each of the at least one input terminal is electrically connected to one end of each of the at least one input key and
wherein the control unit processes the pressed input key based on the key input signal outputted from the key input signal generating unit by identifying the pressed input key based on the voltage of the key input signal, when the control unit receives the logic value ‘1’ from the output terminal.

2. The apparatus of claim 1, wherein the electrical signal generated by pressing the input key is simultaneously transmitted to the key input signal generating unit and to the key interrupt signal generating unit, and the key interrupt signal and the key input signal are simultaneously inputted to the control unit.

3. The apparatus of claim 1, wherein each of the at least one input key has a switch, of which one end is electrically connected to the key input signal generating unit and to the key interrupt signal generating unit, and when the input key is pressed, both ends of the switch are electrically connected to each other.

4. (canceled)

5. (canceled)
